(19) United States
(12) Patent Application Publication
(10) Pub. No.: US 2025/0023270 A1
(43) Pub. Date: Jan. 16, 2025

(54) WIRE HARNESS

(71) Applicant: YAZAKI CORPORATION, Tokyo (JP)

(72) Inventors: Syuji Kimura, Makinohara-shi, Shizuoka (JP); Junya Kato, Makinohara-shi, Shizuoka (JP)

(21) Appl. No.: 18/677,807

(22) Filed: May 29, 2024

(30) Foreign Application Priority Data
Jul. 13, 2023 (JP) 2023-114952

(51) Int. Cl. H01R 12/81; B60R 16/02; H01B 7/00; H02G 15/08

(52) U.S. Cl. CPC H01R 12/81; B60R 16/0207; H01B 7/0045; H02G 15/08

(57) ABSTRACT

A wire harness includes an electric wire module including a plurality of electric wires and an electric wire-side connector provided at an end portion of the plurality of electric wires, and a board module including a flexible board, a first board-side connector provided at one end portion of the flexible board and connected to the electric wire-side connector, and a second board-side connector provided at the other end portion of the flexible board and connected to a connector of a control unit. The flexible board includes a wiring unit having a plurality of wires electrically connected to each of the plurality of electric wires via the electric wire-side connector and the first board-side connector. The wiring unit includes a joint unit that connects at least two of the plurality of wires to each other.

### CROSS-REFERENCE TO RELATED APPLICATION(S)

The present application claims priority to and incorporates by reference the entire contents of Japanese Patent Application No. 2023-114952 filed in Japan on Jul. 13, 2023.

### BACKGROUND OF THE INVENTION

### 1. Field of the Invention

The present invention relates to a wire harness.

### 2. Description of the Related Art

As a technique related to a conventional wire harness, for example, as described in Japanese Patent Application Laid-open No. 2017-117619, a wire harness mounted on a vehicle and configured by bundling sheathed electric wires is known.

Such a wire harness has room for improvement in improving manufacturability. For example, the wire harness described above may include a joint unit that electrically connects conductors of the sheathed electric wire. It is difficult to automate manufacturing of the joint unit, and it is difficult to manufacture the wire harness.

### SUMMARY OF THE INVENTION

Therefore, an object of the present invention is to provide a wire harness that is easy to manufacture.

A wire harness according to one aspect of the present invention includes an electric wire module including a plurality of electric wires and an electric wire-side connector provided at an end portion of the plurality of electric wires; and a board module including a flexible board, a first board-side connector provided at one end portion of the flexible board and connected to the electric wire-side connector, and a second board-side connector provided at other end portion of the flexible board and connected to a connector of an electronic device, wherein the flexible board includes a wiring unit having a plurality of wires electrically connected to each of the plurality of electric wires via the electric wire-side connector and the first board-side connector, and the wiring unit includes a joint unit that connects at least two of the plurality of wires to each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a wire harness according to an embodiment;

FIG. 2 is an exploded perspective view of the wire harness according to the embodiment;

FIG. 3 is an explanatory view of a wire-side connector of the wire harness according to the embodiment;

FIG. 4 is an explanatory view of a flexible board of the wire harness according to the embodiment; and

FIG. 5 is an explanatory view of an assembly state of the wire harness according to the embodiment.

### DETAILED DESCRIPTION OF THE PREFERRED EMBODIMENTS

Hereinafter, an embodiment according to the present invention will be described in detail with reference to the drawings. Note that the present invention is not limited by this embodiment. In addition, constituent elements in the following embodiment include those that can be easily replaced by those skilled in the art or those that are substantially the same.

### Embodiment

The present embodiment relates to a wire harness. In the following description, among a first direction, a second direction, and a third direction intersecting one another, the first direction is referred to as an “extension direction X”, the second direction is referred to as a “width direction Y”, and the third direction is referred to as a “height direction Z”. Here, the extension direction X, the width direction Y, and the height direction Z are orthogonal to each other. The extension direction X corresponds to an extension direction of a trunk portion of the wire harness or a vehicle width direction of a vehicle. The width direction Y corresponds to a width direction of the trunk portion or a width direction in a front-rear direction of the vehicle. The height direction Z corresponds to a height direction of the trunk portion or a height direction of the vehicle. The width direction Y and the height direction Z correspond to an intersection direction intersecting the extension direction X. In addition, each direction used in the following description represents a direction in a state in which each portion is assembled to each other unless otherwise specified. The term “orthogonal” as used herein includes substantially orthogonal.

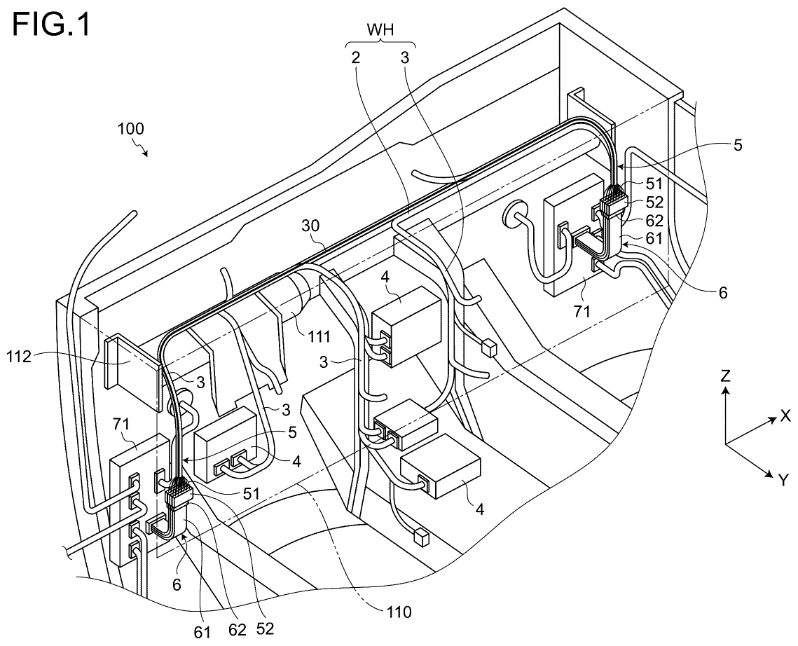

FIG. 1 is a perspective view of a wire harness WH according to an embodiment, illustrating a state of being assembled to a vehicle 100. For example, the wire harness WH is installed and used inside an instrument panel 110 of the vehicle 100. The instrument panel 110 is an interior panel disposed in front of the vehicle interior along the vehicle width direction to face a driver seat and a passenger seat of the vehicle 100. In FIG. 1, the instrument panel 110 is indicated by two-dot chain lines. The wire harness WH connects devices mounted on the vehicle 100 and is used for power supply and signal communication. A reinforcement 111 is provided inside the instrument panel 110. The reinforcement 111 is a structural member or a reinforcing member installed inside the instrument panel 110, and is provided along the vehicle width direction (extension direction X). The reinforcement 111 is also referred to as a reinforce, or the like. The reinforcement 111 is formed of, for example, a metal hollow pipe, and flanges 112 are formed at both end portions. One flange 112 is fixed to the left side of the body of the vehicle 100, and the other flange 112 is fixed to the right side of the body of the vehicle 100.

The wire harness WH includes a trunk portion 2 and a plurality of branch portions 3. The trunk portion 2 is a wiring module having a large number of transmission lines or wires extending in the same direction. The trunk portion 2 is routed along the reinforcement 111, and both ends thereof are connected to the control unit 71. The control unit 71 is an electronic device having a control function, and is, for example, a zone electronic control unit (ECU) that comprehensively controls devices in a peripheral area (zone) of the instrument panel 110, but is not limited thereto. For example, the control unit 71 is installed at a position deviated from the extension direction of the reinforcement 111 in the intersection direction.

The branch portion 3 is provided to be branched from the trunk portion 2, and for example, an electronic device 4 is connected to the end. The branch portion 3 is formed by bundling a plurality of sheathed electric wires, for example, and is connected to the electronic device 4 via a connector attached to a terminal end.

The trunk portion 2 includes an electric wire module 5 and a board module 6. The electric wire module 5 is configured by bundling a plurality of sheathed electric wires. The sheathed electric wire is an electric wire in which an insulating sheath is provided on the outer periphery of a conductor. The electric wire module 5 is provided along the reinforcement 111 of the vehicle 100, for example, and is routed toward the control unit 71 arranged in a direction intersecting the extension direction of the reinforcement 111. The board module 6 is a wiring module having a flexible board 61, and is provided, for example, between one end of the electric wire module 5 and the control unit 71. That is, the board module 6 is provided at an end portion of the trunk portion 2 and is provided at a connection portion of an electronic device such as the control unit 71.

The board module 6 is formed to be shorter than the electric wire module 5 in the extension direction of the trunk portion 2. In the wire harness WH, it is possible to suppress an increase in cost of the wire harness WH by forming the board module 6, which is more expensive than the electric wire module 5, short. In addition, the trunk portion 2 may have a special electric wire 30 in addition to the electric wire module 5 and the board module 6. The special electric wire 30 is an electric wire that transmits a signal or power that is difficult to appropriately transmit in the electric wire module 5 and the board module 6, and is used, for example, for transmission of a signal of high-speed communication or large current power. The special electric wire 30 is routed along the reinforcement 111, for example.

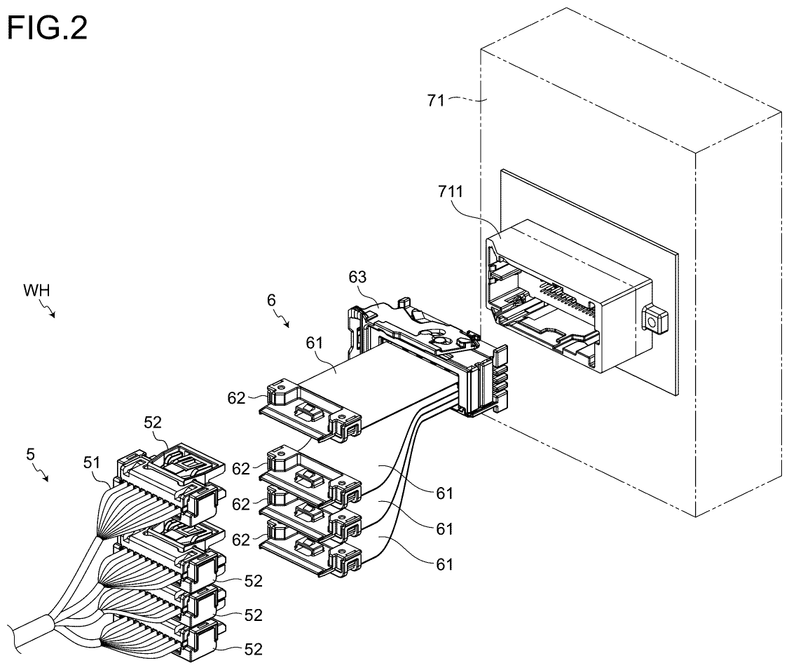

As illustrated in FIG. 2, the electric wire module 5 is connected to the control unit 71 via the board module 6. The electric wire module 5 includes an electric wire 51 and an electric wire-side connector 52. The electric wire 51 is a sheathed electric wire in which an outer periphery of a conductor is covered with an insulating sheath, is routed in a bundled state, and is connected to the electric wire-side connector 52 at an end portion. For example, the electric wires 51 are arranged side by side and connected to the electric wire-side connector 52, and a plurality of electric wire-side connectors 52 are provided to overlap each other in the longitudinal direction. The electric wire module 5 can form a large number of transmission lines by providing the plurality of electric wire-side connectors 52, and can transmit a large number of signals and power.

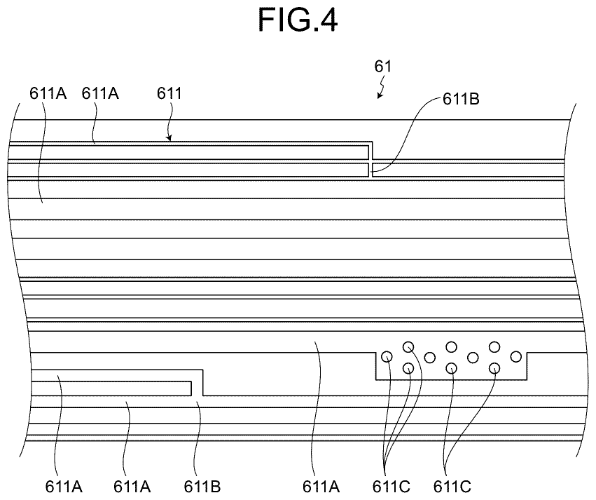

The board module 6 includes a flexible board 61, a first board-side connector 62, and a second board-side connector 63. The flexible board 61 is a planar circuit body in which a circuit is formed in a planar shape, is referred to as a flexible printed circuit (FPC), and is a flexible printed wiring board. The planar shape here also includes a substantially planar shape. The flexible board 61 is formed by, for example, bonding a base film, a conductor foil, and a cover lay with an adhesive layer interposed therebetween. The conductor foil is a wiring pattern of the flexible board 61, and constitutes the wiring unit 611 (see FIG. 4) of the flexible board 61. As the flexible board 61, for example, a double-sided board having wiring patterns on both sides of a base film is used. The flexible board 61 may be a multilayer board of three or more layers, or may be a single-sided board having a wiring pattern only on one side of the base film. In the flexible board 61, electric components such as resistors and capacitors may be mounted on the wiring pattern, or no electric component may be mounted.

The first board-side connector 62 is a connector attached to one end portion of the flexible board 61, and is fitted and connected to the electric wire-side connector 52. The second board-side connector 63 is a connector attached to the other end portion of the flexible board 61, and is connected to the connector 711 provided in the control unit 71 by fitting.

In the board module 6, for example, a plurality of flexible boards 61 are provided and arranged in a stacked manner. The second board-side connector 63 is configured to be attachable in a state where a plurality of flexible boards 61 are stacked. For example, the second board-side connector 63 holds a plurality of terminals attached to each flexible board 61 and electrically connects the terminals to the terminals of the connector 711. The first board-side connector 62 is attached to each of the plurality of flexible boards 61. Each of the plurality of first board-side connectors 62 is fitted and connected to the electric wire-side connector 52.

As described above, the board module 6 includes the plurality of stacked flexible boards 61, so that a large number of transmission lines can be compactly integrated. If a wiring module in which electric wires are bundled is used instead of the board module 6, a large number of transmission lines are configured by a large number of sheathed electric wires, and a considerably thick wiring module is formed. On the other hand, in the wire harness WH according to the present embodiment, by stacking the flexible board 61, the board module 6 can be configured to be thin and small.

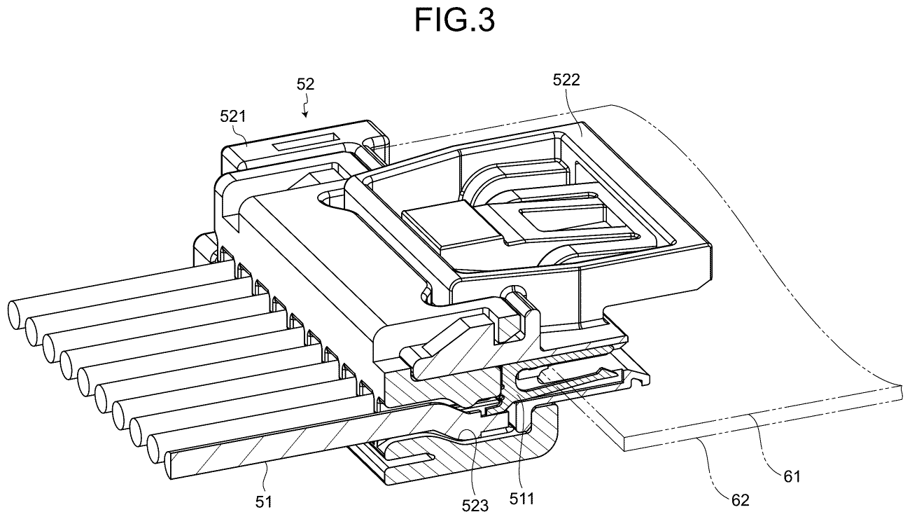

FIG. 3 is a perspective view of the electric wire-side connector 52. In FIG. 3, for convenience of description, a part of the electric wire-side connector 52 is cut out. As illustrated in FIG. 3, the electric wire-side connector 52 is a connector connected to an end portion of the electric wire 51 in the electric wire module 5. A connection terminal 511 is attached to the electric wire 51. The connection terminal 511 is, for example, a crimp terminal, and is connected to the electric wire 51 by crimping. The connection terminal 511 is a tuning fork terminal having a pair of contact pieces extending in the engagement direction, and is accommodated side by side in an accommodation chamber 523 of a housing 521. The connection terminal 511 is electrically connected to the flexible board 61 by inserting the flexible board 61 and the first board-side connector 62 between the pair of contact pieces. That is, the connection terminal 511 is electrically connected to a wire 611A (see FIG. 4) provided on the flexible board 61. A locking unit 522 engageable with the first board-side connector 62 is formed in the housing 521 of the electric wire-side connector 52. The locking unit 522 locks the first board-side connector 62 together with the fitting between the electric wire-side connector 52 and the first board-side connector 62. Although FIG. 3 illustrates an example of the electric wire-side connector 52, the electric wire-side connector 52 may have a structure other than that illustrated in FIG. 3.

FIG. 4 is a schematic plan view of the flexible board 11, but is a view of the surface of the flexible board 11 as viewed from above. As illustrated in FIG. 4, the flexible board 11 is provided with a wiring unit 611 including a plurality of wires 661A. In the flexible board 11, a large number of wires 661A are formed in the extension direction (left-right direction in FIG. 4). The wire 661A is a conductor serving as a signal or power transmission line. The plurality of wires 661A are electrically connected to the plurality of electric wires 51 via the electric wire-side connector 52 and the first board-side connector 62. That is, the plurality of wires 611A are electrically connected to each of the plurality of electric wires 51 in a state where the board module 6 and the electric wire module 5 are connected. The wiring unit 611 is, for example, a circuit portion constituting an electronic circuit or an electric circuit, and functions as, for example, a signal wiring pattern, a power supply wiring pattern, or a ground wiring pattern. The wiring unit 611 includes a joint unit 611B that connects at least two of the plurality of wires 611A to each other. The joint unit 611B is, for example, a portion obtained by branching or merging the plurality of wires 611A in the wiring unit 611. The joint unit 611B mutually connects at least two wires 611A located in the same layer among a plurality of wiring layers constituting the wiring unit 611. In the wire harness WH according to the embodiment, the joint function is incorporated in the flexible board 11 by forming the joint unit 611B in the flexible board 11. Therefore, the wire harness WH according to the embodiment can suppress provision of the joint unit that electrically connects the conductors to each other in the electric wire module 5. Therefore, the wire harness WH according to the embodiment can be easily manufactured, and the manufacturing can be easily automated.

The wiring unit 611 may have a through hole 611C that connects at least two of the plurality of wires 611A to each other. The through hole 611C is, for example, a portion connecting the wire 611A formed on the front surface side of the flexible board 11 and the wire 611A formed on the back surface side. In addition, for example, in a case where the flexible board 11 is a multilayer board having three or more layers, the through hole 611C may connect the wires 611A of different wiring layers. FIG. 4 illustrates a case where a large number of through holes 611C are formed in a part of the wiring unit 611. In the wire harness WH according to the embodiment, since the through hole 611C is formed in the flexible board 11, it is possible to suppress provision of the joint unit that electrically connects the conductors to each other in the electric wire module 5. Therefore, the wire harness WH can be easily manufactured, and the manufacturing can be easily automated.

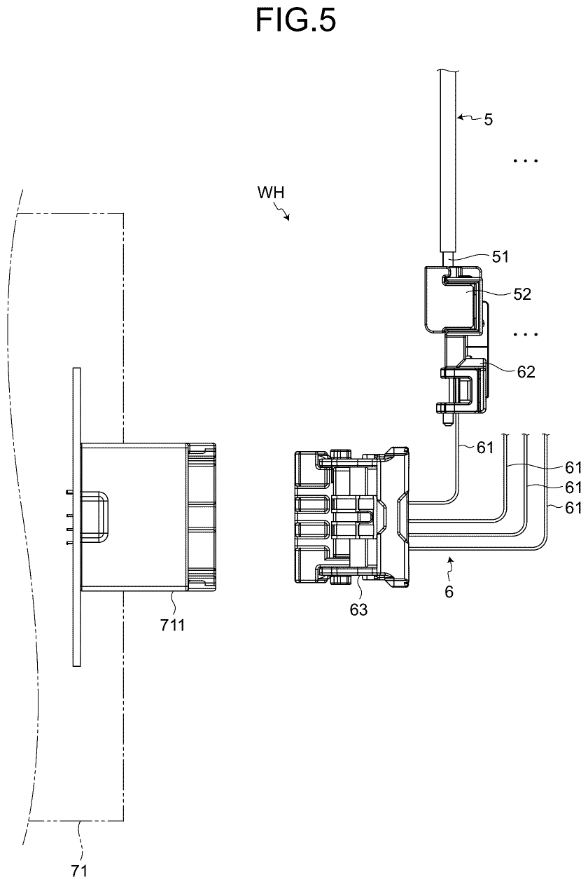

FIG. 5 is an explanatory view of assembly or routing of the wire harness WH according to the embodiment to the vehicle. As illustrated in FIG. 5, in the wire harness WH, as described above, the board module 6 is connected to the control unit 71 by fitting the second board-side connector 63 to the connector 711. At that time, the board module 6 may be provided by bending or curving the flexible board 61 in the thickness direction. That is, the plurality of stacked flexible boards 61 may be bent or curved in the same direction with respect to the thickness direction. Since the flexible board 61 is formed thin, the flexible board is easily bent or curved, and can be bent with a small radius of curvature. Therefore, the mounting space of the board module 6 can be reduced in the wire harness WH.

As described above, the wire harness WH of the present embodiment can connect the plurality of wires 611A by forming the joint unit 611B in the wiring unit 611 of the flexible board 61. Therefore, the wire harness WH according to the present embodiment can suppress provision of the joint unit connecting the plurality of electric wires in the electric wire module 5, and can be easily manufactured.

In addition, since the wire harness WH of the present embodiment has the plurality of flexible boards 61 in which the board modules 6 are stacked, a large number of transmission lines can be compactly combined.

In the wire harness WH of the present embodiment, the plurality of wires 611A can be connected to each other by forming the through hole 611C in the wiring unit 611 of the flexible board 61. Therefore, the wire harness WH according to the present embodiment can suppress provision of the joint unit connecting the plurality of electric wires in the electric wire module 5, and can be easily manufactured.

In the wire harness WH of the present embodiment, the electric wire module 5 is provided along the reinforcement 111 of the vehicle, and the board module 6 is provided between the electric wire module 5 and the control unit 71. Therefore, the wire harness WH of the present embodiment can easily deform the board module 6 and easily perform the routing work by using the board module 6 at the portion connected to the control unit 71.

In addition, the wire harness WH of the present embodiment can reduce the radius of curvature and reduce the mounting space even when the flexible board 61 is bent or curved and installed.

Although the embodiment of the present invention has been exemplified above, the above embodiment is merely an example, and is not intended to limit the scope of the invention. The above-described embodiment can be implemented in various other forms, and various omissions, substitutions, combinations, and changes can be made without departing from the gist of the invention.

For example, in the present embodiment, the case where the wire harness WH is used in the vehicle 100 has been described, but the wire harness of the present invention may be used in an apparatus, a device, or the like other than the vehicle 100. Even such a wire harness can be easily manufactured as in the wire harness WH according to the present embodiment.

According to the wire harness of the present embodiment, the manufacturing can be facilitated.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
an electric wire module including a plurality of electric wires and an electric wire-side connector provided at an end portion of the plurality of electric wires; and
a board module including a flexible board, a first board-side connector provided at one end portion of the flexible board and connected to the electric wire-side connector, and a second board-side connector provided at other end portion of the flexible board and connected to a connector of an electronic device, wherein
the flexible board includes a wiring unit having a plurality of wires electrically connected to each of the plurality of electric wires via the electric wire-side connector and the first board-side connector, and
the wiring unit includes a joint unit that connects at least two of the plurality of wires to each other.

2. The wire harness according to claim 1, wherein
the board module includes a plurality of flexible boards stacked and attached to the second board-side connector, and a plurality of the first board-side connectors attached to the plurality of flexible boards, and
the electric wire module includes a plurality of the electric wire-side connectors connected to the plurality of first board-side connectors, respectively.

3. The wire harness according to claim 1, wherein
the wiring unit includes a through hole that connects at least two of the plurality of wires to each other.

4. The wire harness according to claim 1, wherein
the electric wire module is provided along a reinforcement of a vehicle, and is routed toward the electronic device arranged in a direction intersecting an extension direction of the reinforcement, and
the board module is provided between the electric wire module and the electronic device.

5. The wire harness according to claim 4, wherein
the flexible board is bent or curved in a thickness direction.
